(19) United States
(12) Patent Application Publication
(10) Pub. No.: US 2026/0140739 A1
(43) Pub. Date: May 21, 2026

(54) DATA ACCESS PROCESSING METHOD AND APPARATUS FOR GPU, AND STORAGE MEDIUM

(71) Applicant: Moore Threads Technology Co., Ltd., Beijing (CN)

(72) Inventor: Yuhao Liu, Beijing (CN)

(73) Assignee: Moore Threads Technology Co., Ltd., Beijing (CN)

(21) Appl. No.: 19/395,036

(22) Filed: Nov. 20, 2025

Related U.S. Application Data
(63) Continuation of application No. PCT/CN2024/094534, filed on May 21, 2024.

(30) Foreign Application Priority Data
May 26, 2023 (CN) 202310602802.9

(51) Int. Cl. G06F 9/34; G06F 12/0802; G06F 12/1009; G06F 13/16; G06T 1/20

(52) U.S. Cl. CPC G06F 9/34; G06F 12/0802; G06F 12/1009; G06F 13/1621; G06T 1/20; G06F 2212/302

(57) ABSTRACT

The present application relates to a data access processing method and apparatus for a GPU, and a storage medium. The method comprises: outputting a first access request, the first access request indicating a data address of a cross-partition SRS accessed this time; performing a hit test for the first access request; and when the result of the hit test is a first test result, reading data corresponding to the data address from a cache line and returning the same, wherein the first test result indicates that the data address accessed this time is hit and a data address accessed historically is hit. That is, a hardware circuit for reading a cache inside a GPU is provided, such that when a data address accessed this time is hit and a data address accessed historically is hit, data can be directly read from a cache line and returned.

### CROSS-REFERENCE TO RELATED APPLICATION

The present application is based upon and claims the benefit of priority of Chinese Patent Application No. 202310602802.9, filed with the CNIPA on May 26, 2023 and International Application No. PCT/CN2024/094534 filed on May 21, 2024, the entire contents of which are incorporated herein by reference.

### TECHNICAL FIELD

The present disclosure relates to the field of computer technology, and in particular to a data access processing method and apparatus for a GPU, and a storage medium.

### BACKGROUND

As the increasingly broader application of Graphics Processing Unit (GPU), increasingly higher requirements are being imposed on the performances of GPU.

A GPU usually includes multiple various modules therein. When carrying out cross-partition data accesses, the multiple various modules, if the modules are spaced relatively far from one another, may be unable to satisfy certain timing requirements. Currently, in order to satisfy the timing requirements for inter-module communications, a flip-flop or a First Input First Output (FIFO) memory may be disposed between the modules.

However, this may result in excessive delay between initiating an access request and receiving return data for cross-partition modules, thereby degrading system performance. The related art has not yet provided a reasonable and effective solution to this problem.

### SUMMARY

In view of this, a data access processing method and apparatus for a GPU and a storage medium are proposed.

In a first aspect, an embodiment of the present disclosure provides a data access processing apparatus for a GPU, comprising: a bridging module and a scheduling module, the bridging module comprising a requesting unit and a scheduling multiplexing unit, the scheduling module comprising a scalar register (e.g., slot register), SRS;
the bridging module configured to output, by the requesting unit, a first access request, the first access request configured to indicate a data address of the SRS of the scheduling module being cross-partition accessed for the first access;
the bridging module configured further to perform, by the scheduling multiplexing unit, a hit test for the first access request;
the bridging module configured further to read and return data corresponding to the data address from a cache line of the scheduling module based on that a result of the hit test is a first test result, the first test result indicating that the data address accessed for the first access is hit and a data address accessed historically is hit.

In a possible implementation, the bridging module is configured further to:
acquire, based on the data address accessed for the first access, an index of a corresponding first cache line from a Look-up Table Address Queue;
acquire, based on the index of the first cache line, corresponding data from a Look-up Table Data Queue;
return the data acquired after performing a flopping operation thereon, the flopping operation configured to indicate outputting the data after delaying the data by k clock cycles, the k being an integer.

In one other possible implementation, the bridging module is configured further to:
store the data address accessed for the first access in a Status Queue based on that a result of the hit test is a second test result, the Status Queue configured to indicate returning corresponding data in turn based on an access order;
wherein the second test result indicates that the data address accessed for the first access is hit and the data address accessed historically is not hit, or the data address accessed for the first access is not hit.

In one other possible implementation, depth of the Status Queue is set based on a data cycle from outputting the first access request to returning data.

In one other possible implementation, the Status Queue is configured to store a data address that is not hit and a second data address that is hit in a case that a first data address is not hit, the first data address being a data address accessed before the second data address is accessed.

In one other possible implementation, an updating condition for the Status Queue includes:
updating data in the Status Queue based on that an earliest data address in the Status Queue is identical to a return address in a Return Address Queue.

In one other possible implementation, the bridging module further comprises an arbiter, the bridging module is configured further to:
determine, in a Lock Flag Queue, a second cache line that is not locked, the Lock Flag Queue indicating whether or not each cache line in a Look-up Table Address Queue is locked;
update the data address accessed for the first access in the corresponding second cache line of the Look-up Table Data Queue, and update a Valid Flag corresponding to the second cache line in a Look-up Table Valid Queue to a first flag, the first flag configured to indicate that data is invalid;
send the first access request to the arbiter, the arbiter configured to select among a plurality of cross-partition access requests.

In one other possible implementation, the bridging module further comprises a First Input First Output, FIFO, memory, the bridging module is configured further to:
hit, by the arbiter, a second access request, the second access request being one access request among the plurality of cross-partition access requests;
send, by the FIFO memory, a data address indicated by the second access request to the SRS in the scheduling module;
acquire, based on a data address of return data returned by the SRS, an index of a corresponding third cache line from a Look-up Table Address Queue;
update, based on the index of the third cache line, the return data in the third cache line of a Look-up Table Data Queue, and update a Valid Flag corresponding to the third cache line in a Look-up Table Valid Queue to a second flag, the second flag configured to indicate that data is valid.

In one other possible implementation, the bridging module further comprises a comparing unit, the bridging module configured further to:
perform, by the comparing unit, detection on the Status Queue, the Look-up Table Address Queue, and the Look-up Table Valid Queue;
read and return data from a fourth cache line based on that a data address of an earliest access in the Status Queue is identical to a data address in the Look-up Table Address Queue, and that a corresponding Valid Flag indicates that the data in the fourth cache line is valid.

In one other possible implementation, the apparatus is implemented through a hardware circuit.

In a second aspect, an embodiment of the present disclosure provides a data access processing method for a GPU, wherein the method comprises:
outputting a first access request, the first access request configured to indicate a data address of a cross-partition scalar register SRS accessed for the first access;
performing a hit test for the first access request;
reading and returning data corresponding to the data address from a cache line based on that a result of the hit test is a first test result, the first test result indicating that the data address accessed for the first access is hit and a data address accessed historically is hit.

In a possible implementation, the reading and returning data corresponding to the data address from a cache line based on that a result of the hit test is the first test result comprises:
acquiring, based on the data address accessed for the first access, an index of a corresponding first cache line from a Look-up Table Address Queue;
acquiring, based on the index of the first cache line, corresponding data from a Look-up Table Data Queue;
returning the data acquired after performing a flopping operation thereon, the flopping operation configured to indicate outputting the data after delaying the data by k clock cycles, the k being an integer.

In one other possible implementation, the method further comprises:
storing the data address accessed for the first access in a Status Queue based on that a result of the hit test is a second test result, the Status Queue configured to indicate returning corresponding data in turn based on an access order;
wherein the second test result indicates that the data address accessed for the first access is hit and the data address accessed historically is not hit, or that the data address accessed for the first access is not hit.

In one other possible implementation, a depth of the Status Queue is set based on a data cycle from outputting the first access request to returning the data.

In one other possible implementation, the Status Queue is configured to store a data address that is not hit and a second data address that is hit in a case that a first data address is not hit, the first data address being a data address accessed before the second data address is accessed.

In one other possible implementation, an updating condition for the Status Queue includes:
updating data in the Status Queue based on that an earliest data address in the Status Queue is identical to a return address in a Return Address Queue.

In one other possible implementation, subsequent to storing the data address accessed for the first access in the Status Queue based on that the result of the hit test is the second test result:
determining, in a Lock Flag Queue, a second cache line that is not locked, the Lock Flag Queue indicating whether or not each cache line in a Look-up Table Address Queue is locked;
updating the data address accessed for the first access in the corresponding second cache line of the Look-up Table Data Queue, and updating a Valid Flag corresponding to the second cache line in a Look-up Table Valid Queue to a first flag, the first flag configured to indicate that data is invalid;
sending the first access request to an arbiter, the arbiter configured to select among a plurality of cross-partition access requests.

In one other possible implementation, the method further comprises:
hitting, by the arbiter, a second access request, the second access request being one access request among the plurality of cross-partition access requests;
sending a data address indicated by the second access request to the SRS;
acquiring, based on a data address of return data returned from the SRS, an index of a corresponding third cache line from a Look-up Table Address Queue;
updating, based on the index of the third cache line, the return data in the third cache line of a Look-up Table Data Queue, and updating a Valid Flag corresponding to the third cache line in a Look-up Table Valid Queue to a second flag, the second flag configured to indicate that the data is valid.

In one other possible implementation, the method further comprises:
performing detection on the Status Queue, the Look-up Table Address Queue, and the Look-up Table Valid Queue;
reading and returning data from a fourth cache line based on that a data address of an earliest access in the Status Queue is identical to a data address in the Look-up Table Address Queue, and that a corresponding Valid Flag indicates that data in the fourth cache line is valid.

In one other possible implementation, the method is implemented through a hardware circuit.

In a third aspect, an embodiment of the present disclosure provides a data access processing apparatus for a GPU, comprising:
a processor;
a memory configured to store processor-executable instructions;
wherein the processor is configured to, when executing the instructions, implement the method of the first aspect or any one of the possible implementations of the first aspect.

In a fourth aspect, an embodiment of the present disclosure provides a non-transitory computer readable storage medium having computer program instructions stored thereon, wherein the computer program instructions, when executed by a processor, implement the method of the first aspect or any one of the possible implementations of the first aspect.

In a fifth aspect, an embodiment of the present disclosure provides a computer program product comprising computer readable code, or a non-transitory computer readable storage medium carrying computer readable code, wherein when the computer readable code runs in a computer apparatus, a processor of the computer apparatus executes the method of the first aspect or any one of the possible implementations of the first aspect.

In summary, in an embodiment of the present disclosure, by outputting a first access request, the first access request configured to indicate a data address of a cross-partition SRS accessed this time; performing a hit test for the first access request; reading data corresponding to the data address from a cache line and returning same when a result of the hit test is a first test result, the first test result indicating that the data address accessed this time is hit and a data address accessed historically is hit, that is, by providing a hardware circuit for reading cache inside a GPU, it is possible to directly read and return data from cache lines in a case that the data address accessed this time is hit and a data address accessed historically is hit, which dramatically reduces delay of data in cross-partition SRS access and makes it possible to improve the system performance of the GPU in the scenario of cross-partition data access.

### BRIEF DESCRIPTION OF THE DRAWINGS

The drawings, which are incorporated in and constitute a part of the description, illustrate exemplary embodiments, features, and aspects of the present disclosure and, along with the description, serve to explain the principle of the present disclosure.

FIG. 1 is a structural diagram of the GPU provided in an exemplary embodiment of the present disclosure.

FIG. 2 is a flow chart of the data access processing method for a GPU provided in an exemplary embodiment of the present disclosure.

FIG. 3 is a structural diagram of the Status Queue provided in an exemplary embodiment of the present disclosure.

FIG. 4 is a structural diagram of the Lock Flag Queue provided in an exemplary embodiment of the present disclosure.

FIG. 5 is a structural diagram of the Look-up Table Address Queue provided in an exemplary embodiment of the present disclosure.

FIG. 6 is a structural diagram of the Look-up Table Data Queue provided in an exemplary embodiment of the present disclosure.

FIG. 7 is a structural diagram of the Look-up Table Valid Queue provided in an exemplary embodiment of the present disclosure.

FIG. 8 is a flow chart of the data access processing method for a GPU provided in another exemplary embodiment of the present disclosure.

FIG. 9 is a structural diagram of the data access processing apparatus for a GPU provided in an embodiment of the present disclosure.

### DETAILED DESCRIPTION

Various exemplary embodiments, features, and aspects of the present disclosure will be explained in detail below with reference to the drawings. In the drawings, the same reference signs denote elements with the same or similar functions. Although various aspects of the embodiments are shown in the drawings, unless otherwise specified, the drawings are not necessarily drawn to scale.

The word “exemplary” used here means “serving as an example, embodiment, or illustration”. Any embodiment described here as “exemplary” is not necessarily to be interpreted as superior to or better than other embodiments.

In addition, to better explain the present disclosure, numerous details are given in the following embodiments. It is appreciated by those skilled in the art that the present disclosure can still be implemented without some specific details. In some embodiments, methods, means, elements, and circuits well known to those skilled in the art are not described in detail in order to highlight the gist of the present disclosure.

In an embodiment of the present disclosure, by providing a hardware circuit for reading cache inside a GPU, it is possible to directly read and return data from cache lines in a case that the data address accessed this time is hit and a data address accessed historically is hit, which dramatically reduces delay of data in cross-partition SRS access and makes it possible to improve the system performance of the GPU in the scenario of cross-partition data access. In addition, the hardware circuit provided in the embodiment of the present disclosure supports sequence-keeping operations, thereby reducing resource consumption by the requesting end for executing sequence-keeping functions.

First, the application scenario concerned in the present disclosure is described.

An embodiment of the present disclosure provides a data access processing method for a GPU, of which the executing entity is the GPU. The GPU can be connected with various components of the computer system through interfaces and wiring and perform various functions and process data of the computer device by running or executing software programs and/or modules stored in the memory and scheduling data stored in the memory.

The GPU provided in an embodiment of the present disclosure comprises a hardware circuit for reading cache. The GPU comprises multiple various modules. The GPU comprises at least one bridging module and at least one scheduling module. The bridging module is configured to receive an access request for accessing the scheduling module and receive data returned by the scheduling module. The scheduling module comprises a SRS. The SRS is configured to store data.

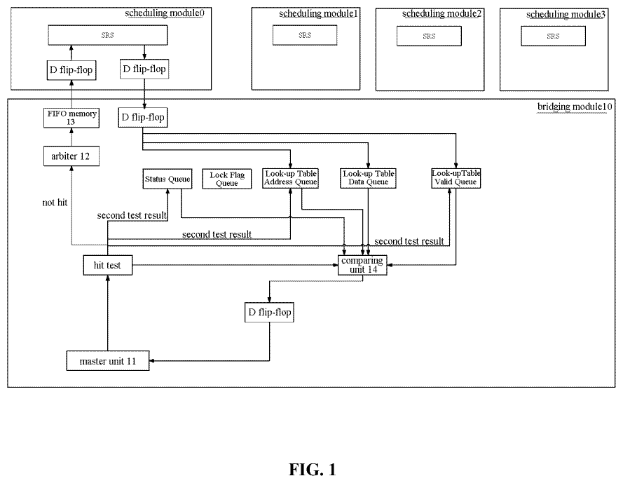

Please refer to FIG. 1, which is a structural diagram of the GPU provided in an exemplary embodiment of the present disclosure.

The requesting end of the GPU comprises one bridging module 10. The bridging module 10 includes 5 requesting units, i.e., 5 master units 11. The returning end of the GPU includes 4 scheduling modules. For instance, the 5 master units 11 include a master0 unit, a master1 unit, a master2 unit, a master3 unit, and a master4 unit. The 4 scheduling modules include scheduling module 0, scheduling module 1, scheduling module 2, and scheduling module 3.

Each scheduling module includes a SRS inside. Data stored in the SRSs of the 4 scheduling modules is the same. Providing 4 identical SRSs in the scheduling module inside the GPU aims to prevent degrading of system performance due to concentrated accesses to one single SRS. It is to be noted that the number of each module is not limited in the embodiment of the present disclosure.

Optionally, the bridging module 10 includes, but not limited to, the following modules: a master unit 11, an arbiter 12 i.e. arb unit, a FIFO memory 13, and a comparing unit 14.

Optionally, interfaces for accessing the SRS include, but not limited to, the following interfaces: an Srs_valid interface, an Srs_enable interface, and an Srs_rd_addr interface. The Srs_valid interface is configured to receive a Valid Flag corresponding to the access request. The Srs_enable interface is configured to receive an Enable Flag corresponding to the access request. The Srs_rd_addr interface is configured to receive a data address corresponding to the access request.

Optionally, interfaces for return data of the SRS include, but not limited to, the following interfaces: an Srs_rtn_valid interface and an Srs_rtn_data interface. The Srs_rtn_valid interface is configured to receive a Valid Flag of the return data of the SRS. The Srs_rtn_data interface is configured to receive the return data of the SRS.

For the ease of explanation, the figure schematically illustrates the processing flow for the data access of one master unit 11 only. The master unit 11 may be the master0 unit, or the master1 unit, or the master2 unit, or the master3 unit, or the master4 unit.

The bridging module 10 is configured to, when the SRS access request is received through the master unit 11, output a read request i.e. a first access request. The first access request is configured to indicate the data address of the cross-partition SRS accessed this time.

The bridging module 10 is further configured to perform a hit test for the first access request.

The bridging module 10 is further configured to read data corresponding to the data address from a cache line and return the same when a result of the hit test is a first test result, the first test result indicating that the data address accessed this time is hit and a data address accessed historically is hit.

Optionally, the bridging module 10 is further configured to acquire, according to the data address accessed this time, an index of a corresponding first cache line from a Look-up Table Address Queue; acquire, according to the index of the first cache line, corresponding data from a Look-up Table Data Queue; and return the data acquired after performing a flopping operation thereon.

Optionally, the bridging module 10 is further configured to store the data address accessed this time in a Status Queue when a result of the hit test is a second test result, the Status Queue configured to indicate returning corresponding data in turn according to an access order, wherein the second test result indicates that the data address accessed this time is hit and a data address accessed historically is not hit, or the data address accessed this time is not hit.

Optionally, the bridging module 10 is further configured to determine, in a Lock Flag Queue, a second cache line that is not locked, the Lock Flag Queue indicating whether or not each cache line in a Look-up Table Address Queue is locked; update the data address accessed this time in a corresponding second cache line of the Look-up Table Data Queue, and update a Valid Flag corresponding to the second cache line in a Look-up Table Valid Queue to a first flag, the first flag configured to indicate that data is invalid; send the first access request to the arbiter 12, the arbiter 12 configured to select among a plurality of cross-partition access requests.

Optionally, the bridging module 10 is further configured to hit, by the arbiter 12, a second access request, the second access request being one access request among the plurality of cross-partition access requests; send a data address indicated by the second access request to the FIFO memory 13, the FIFO memory 13 configured to cut the timing of cross-partition data accesses, wherein the output parameter of the FIFO memory 13 is still the data address indicated by the second access request, the output parameter of the FIFO memory 13 needs to undergo a flopping operation on the scheduling module side, too (e.g., transmitted to a D flip-flop configured to carry out a flopping operation), and the corresponding second access request is sent to the SRS and stored; after the return data returned by the SRS has undergone the flopping operation (e.g., two flopping operations), acquire an index of a corresponding third cache line from a Look-up Table Address Queue; and update, according to the index of the third cache line, the return data in a third cache line of a Look-up Table Data Queue, and update a Valid Flag corresponding to the third cache line in a Look-up Table Valid Queue to a second flag, the second flag configured to indicate that data is valid, thereby completing the operation of storing the return data in the queue.

Here, the flopping operation is configured to indicate outputting a parameter after delaying the parameter by several clock cycles. That is, the output parameter of the FIFO memory 13 undergoing a flopping operation on the scheduling module side includes: outputting the output parameter of the FIFO memory 13 after delaying the same by n clock cycles, n being an integer. For instance, n may be 1 or 2 or 3, which is not limited in the embodiment of the present disclosure. The return data returned by SRS above undergoing a flopping operation includes: outputting the return data returned by the SRS after delaying the same by m clock cycles, m being an integer. For instance, m may be 1 or 2 or 3, which is not limited in the embodiment of the present disclosure.

It is to be noted that data requested according to the embodiment of the present disclosure may include at least one of data representing an image, image color data (e.g., RGB data), or image position data (e.g., XYZ coordination data). The data requested according to the embodiment of the present disclosure may further include data of other types, which is not limited in the embodiment of the present disclosure.

It is to be further noted that the number of requesting unit in the bridging module and the number of the scheduling module are not limited in the embodiment of the present disclosure. That is, the requesting unit in the bridging module may be one or more, the scheduling module may be one or more. For the ease of explanation, the embodiment of the present disclosure is described exemplarily, with five requesting units in the bridging module and four scheduling modules.

Optionally, the bridging module 10 is further configured to perform detection by the comparing unit 14 on the Status Queue, the Look-up Table Address Queue, and the Look-up Table Valid Queue; and when a data address accessed the earliest in the Status Queue is identical to a data address in the Look-up Table Address Queue, and a corresponding Valid Flag indicates that data in a fourth cache line is valid, read the data from the fourth cache line and return the same.

Next, the data access processing method for a GPU provided in the embodiment of the present disclosure is described with reference to several exemplary embodiments.

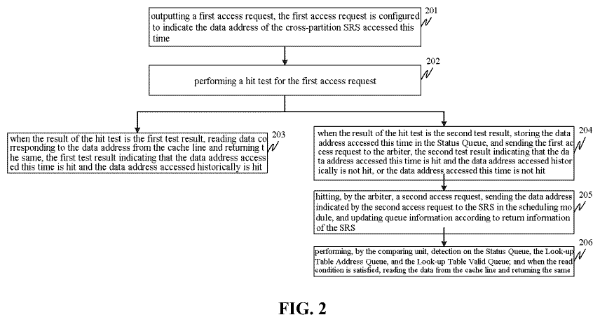

Please refer to FIG. 2, which is a flow chart of the data access processing method for a GPU provided in an exemplary embodiment of the present disclosure. This embodiment is described exemplarily for the method as applied to the GPU shown in FIG. 1. The method comprises the following steps.

Step 201, outputting a first access request, the first access request configured to indicate the data address of the cross-partition SRS accessed this time.

A read request is output by the master unit, and when it is detected that at least one second flag is present among a plurality of Lock Flags of a Lock Flag Queue, Step 202 is carried out, wherein a Lock Flag is configured to indicate whether the corresponding cache line is locked. When the Lock Flag is a first flag, it is indicated that the cache line is locked; when the Lock Flag is a second flag, it is indicated that the cache line is not locked. For instance, the first flag is 1, and the second flag is 0, which is not limited in the embodiment of the present disclosure.

Step 202, performing a hit test for the first access request.

Optionally, a hit test is performed for the first access request to obtain the result of the hit test. The result of the hit test includes a first test result or a second test result, wherein the first test result indicates that the data address accessed this time is hit and the data address accessed historically is hit, the second test result indicates that the data address accessed this time is hit and a data address accessed historically is not hit, or the data address accessed this time is not hit.

Optionally, the data address accessed historically is a data address of an SRS indicated by an access request received before the first access request is received. Exemplarily, the access request received before the first access request is received is any access request received within a target time period before the first access request is received. The target time period may be set by default or set by customization, which is not limited in the embodiment of the present disclosure.

Exemplarily, a result that the data address accessed this time is hit and the data address accessed historically is hit is also referred to as a hit result; a result that the data address accessed this time is hit and the data address accessed historically is not hit is also referred to as a hit on miss result; and a result that the data address accessed this time is not hit is also referred to as a miss result. That is, the first test result is a hit result; the miss result may be a miss result or a hit on miss result.

When the result of the hit test is the first test result, indicating that the data address accessed this time is hit and the data address accessed historically is hit, Step 203 is executed. When the result of the hit test is the second test result, indicating that the data address accessed this time is hit and the data address accessed historically is not hit, or the data address accessed this time is not hit, Step 204 is executed.

Step 203, when the result of the hit test is the first test result, reading data corresponding to the data address from the cache line and returning the same, the first test result indicating that the data address accessed this time is hit and the data address accessed historically is hit.

Optionally, according to the data address accessed this time, an index of the corresponding first cache line is acquired from the Look-up Table Address Queue; according to the index of the first cache line, corresponding data is acquired from the Look-up Table Data Queue; the data acquired is returned to the requesting unit after subjected to a flopping operation, the flopping operation configured to indicate outputting the data after delaying the same by k clock cycles, k being an integer. Then, a read access request is complete for one time. For instance, k may be 1 or 2 or 3, which is not limited in the embodiment of the present disclosure.

Step 204, when the result of the hit test is the second test result, storing the data address accessed this time in the Status Queue, and sending the first access request to the arbiter, the second test result indicating that the data address accessed this time is hit and the data address accessed historically is not hit, or the data address accessed this time is not hit.

Here, the Status Queue is configured to indicate returning corresponding data in turn according to the access order. Optionally, the Status Queue is configured to store a data address that is not hit and a second data address that is hit in a case that a first data address is not hit, the first data address being a data address accessed before the second data address is accessed.

Optionally, when the result of the hit test is the second test result, storing the data address accessed this time in the Status Queue, and sending the first access request to the arbiter includes: determining, in a Lock Flag Queue, a second cache line that is not locked, the Lock Flag Queue indicating whether or not each cache line in a Look-up Table Address Queue is locked; updating the data address accessed this time in the corresponding second cache line of the Look-up Table Data Queue, and updating the Valid Flag corresponding to the second cache line in the Look-up Table Valid Queue to the first flag, the first flag configured to indicate that data is invalid; and sending the first access request to the arbiter, the arbiter configured to select among a plurality of cross-partition access requests.

Optionally, the updating condition for the Status Queue includes: updating data in the Status Queue when the earliest data address in the Status Queue is identical to a return address in a Return Address Queue.

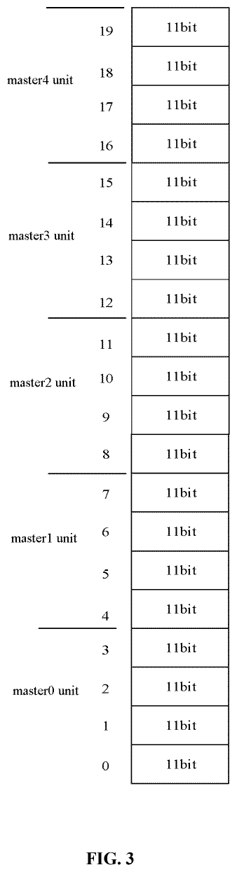

The Status Queue is configured to store, according to an access order, a plurality of data addresses to be accessed. Optionally, the depth of the Status Queue is set according to a data cycle from outputting the first access request to returning data. For instance, the depth of the Status Queue is set to a positive integer greater than the data cycle, which is not limited in the embodiment of the present disclosure. In an exemplary example, the Status Queue is structured as illustrated in FIG. 3, in which each master0 unit corresponds to four positions; each position is configured to store a data address of 11 bits. The access of the master0 unit is placed in positions 0 to 3 of the Status Queue. Position 0 is configured to store the data address accessed the earliest. Positions 1, 2, and 3 are configured to store sequentially data addresses accessed in turn. When the data address stored in position 0 matches a data address in the Look-up Table Address Queue and the Valid Flag of the corresponding cache line in the Look-up Table Valid Queue indicates that data is valid, which means that the return data for the data address accessed the earliest has come, the corresponding return data is returned and data in positions 1 to 3 is moved downwards to positions 0 to 2. The method provided in the embodiment of the present disclosure is capable of ensuring that the order in which data returns is in line with the access order, satisfying the sequence-keeping requirement. Likewise, operations of the master1 unit, the master2 unit, the master3 unit, and the master4 unit may analogously refer to the operation of the master0 unit, which will not be repeated herein.

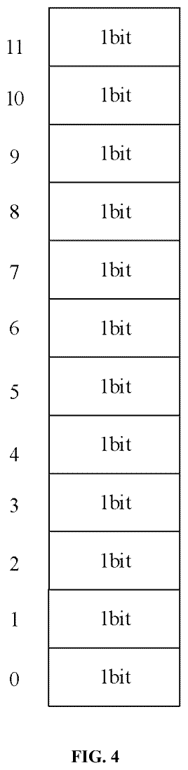

In an exemplary example, the Lock Flag Queue is structured as illustrated in FIG. 4. The Lock Flag Queue includes Lock Flags corresponding to a plurality of cache lines, respectively. Each Lock Flag contains information of 1 bit. The Lock Flag being 1 indicates that the cache line is locked, the Lock Flag being 0 indicates that the cache line is not locked, which is not limited in the embodiment of the present disclosure. The Lock Flag Queue is configured to carry out a lock detection mechanism when the result of the hit test is the second test result, that is, comparing data addresses in the Status Queue and the Look-up Table Address Queue; when a data address of the corresponding cache line in the Look-up Table Address Queue is identical to a data address in the Status Queue, lifting the Lock Flag of the corresponding cache line to indicate that the cache line is locked, and a data address accessed in a subsequent new access request (if any) will not be updated in the corresponding Look-up Table Address Queue; and when there is no identical data address between the Status Queue and the Look-up Table Address Queue, the corresponding Lock Flag is lowered to indicate that the cache line is not locked.

Here, the arbiter is configured to select among a plurality of cross-partition access request. Such a selection may include polling selection or custom selection. The custom selection may be custom selection performed according to the application scenario, which is not limited in the embodiment of the present disclosure.

Step 205, hitting, by the arbiter, a second access request, sending the data address indicated by the second access request to the SRS in the scheduling module, and updating queue information according to return information of the SRS.

Optionally, the second access request is hit by the arbiter by custom selection or polling selection, the second access request being one access request of the plurality of cross-partition access requests; the data address indicated by the second access request is sent to the SRS in the scheduling module; according to the data address of the return data returned by the SRS, an index of a corresponding third cache line is acquired from the Look-up Table Address Queue; according to the index of the third cache line, the return data is updated in a third cache line of the Look-up Table Data Queue, and the Valid Flag corresponding to the third cache line in the Look-up Table Valid Queue is updated to the second flag indicating that data is valid.

Optionally, when the arbiter selects a corresponding second access request that is one access request among a plurality of cross-partition access requests, the data address indicated by the second access request is input to the FIFO memory configured to cut the timing of cross-partition data accesses.

Optionally, the output parameter of the FIFO memory, i.e. the data address indicated by the second access request undergoes a flopping operation (e.g., input to the D flip-flop configured to perform the flopping operation), and the corresponding second access request is sent to the SRS and stored.

Optionally, the return data returned by the SRS carries the data address accessed this time. After the return data returned by the SRS undergoes the flopping operation (e.g., two flopping operations), updating queue information according to return information of the SRS includes: acquiring the index of the corresponding third cache line from the Look-up Table Address Queue; according to the index of the third cache line, updating the return data in the third cache line of the Look-up Table Data Queue, and updating the Valid Flag corresponding to the third cache line in the Look-up Table Valid Queue to the second flag, the second flag configured to indicate that data is valid, thereby completing the operation of storing the return data in the queue.

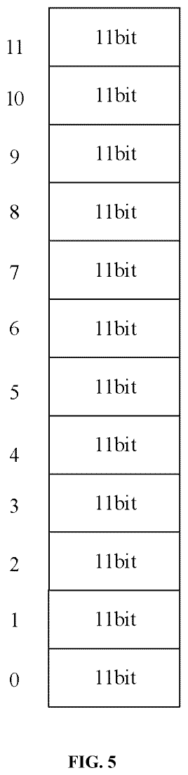

In an exemplary example, the Look-up Table Address Queue is structured as illustrated in FIG. 5. Each line stores a data address of 11 bits. The Look-up Table Address Queue is configured to store the data address of the Look-up Table data stored in the SRS, and update the address accessed in the corresponding Look-up Table Address Queue and Status Queue when detecting, after outputting the first access request, that a Lock Flag of a cache line indicates that the cache line is not locked.

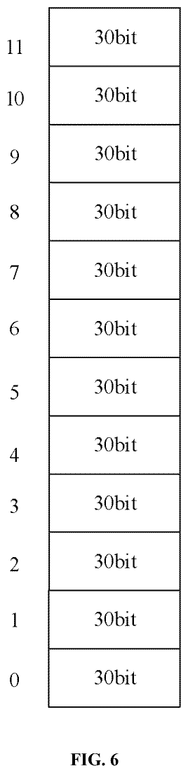

In an exemplary example, the Look-up Table Data Queue is structured as illustrated in FIG. 6. Each line stores return data of 30 bits. The Look-up Table Data Queue is configured to store the return data returned by the SRS, and update the Look-up Table Data Queue of the corresponding cache line when the data address of the return data is identical to the data address in the Look-up Table Address Queue.

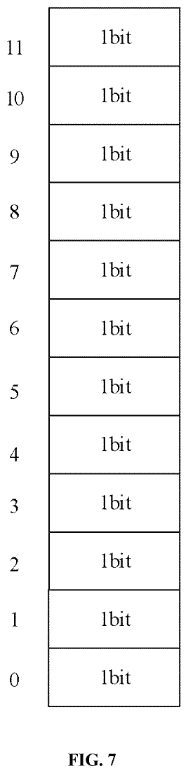

In an exemplary example, the Look-up Table Valid Queue is structured as illustrated in FIG. 7. Each line stores a Valid Flag of 1 bit. The Valid Flag being 1 indicates that data is valid, the Valid Flag being 0 indicates that data is invalid. The structure of the Look-up Table Valid Queue is the same with the Lock Flag Queue. When the data address of the return data returned by the SRS is present, the data address of the return data is compared to the data address in the Look-up Table Address Queue; if they are the same, the return data is updated in the Look-up Table Data Queue and the Valid Flag of the corresponding cache line in the Look-up Table Valid Queue is updated to 1.

Step 206, performing, by the comparing unit, detection on the Status Queue, the Look-up Table Address Queue, and the Look-up Table Valid Queue; and when the read condition is satisfied, reading the data from the cache line and returning the same.

Optionally, detection is carried out by the comparing unit for the Status Queue, the Look-up Table Address Queue, and the Look-up Table Valid Queue; when the read condition is satisfied, the data is read from the cache line and returned; and when the read condition is not satisfied, wait for data to return until the read condition is satisfied. Here, the read condition is that the data address accessed the earliest in the Status Queue is identical to the address in the Look-up Table Address Queue and the corresponding Valid Flag indicates that data in the fourth cache line is valid.

Optionally, when the read condition is satisfied, that is, the read condition is that the data address accessed the earliest in the Status Queue is identical to the address in the Look-up Table Address Queue and the corresponding Valid Flag indicates that data in the fourth cache line is valid, the return data is read from the fourth cache line and returned to the corresponding requesting unit.

It is noted that during the operation of the GPU system, there is a case where the result of the hit test for the first access request is the miss result while the result of the hit test for the second access request is the hit result, which may be referred to as the hit on miss result. In that case, the data address accessed secondly is updated in the Status Queue, and the data address of the second hit is not processed until the data returned for the first miss result is updated in the Look-up Table Data Queue and the Look-up Table Valid Queue and is returned to the corresponding requesting unit after subjected to a comparison by the comparing unit, and a shift operation is executed for the Status Queue, that is, the Status Queue would be moved downwards entirely, thereby meeting the sequence-keeping requirement. Here, the sequence-keeping operation provided in the embodiment of the present disclosure indicates that even when the result of the hit test corresponding to the current access request is the hit result, the corresponding data cannot be returned directly, but must wait and not be returned in order until the access request corresponding to the earliest miss result is responded to.

Hence, by directly reading data from the cache line and returning the same in the case that the data address accessed this time is hit and the data address accessed historically is hit, for a cross-partition hardware structure, compared to the related art that does not provide a read cache structure and requires 6 cycles for one single access, the hardware circuit provided in the embodiment of the present disclosure which comprises a read cache structure requires 7 cycles for one single access in the case that the data address of a cross-partition access is not hit, and reduces the time length for one single access to one cycle in the case that the data address of a cross-partition access is hit. Thus, the delay of data in cross-partition SRS access is reduced dramatically, thereby improving the system performance of the GPU.

In addition, in the design of the Status Queue, by setting the miss result and the hit on miss result and writing them both in the Status Queue, and configuring the mechanism in which the Status Queue prioritizes the processing of the data address accessed the earliest, it is ensured that data is returned in a sequence-keeping manner, thereby reducing the resource consumption by the requesting end for executing sequence-keeping functions.

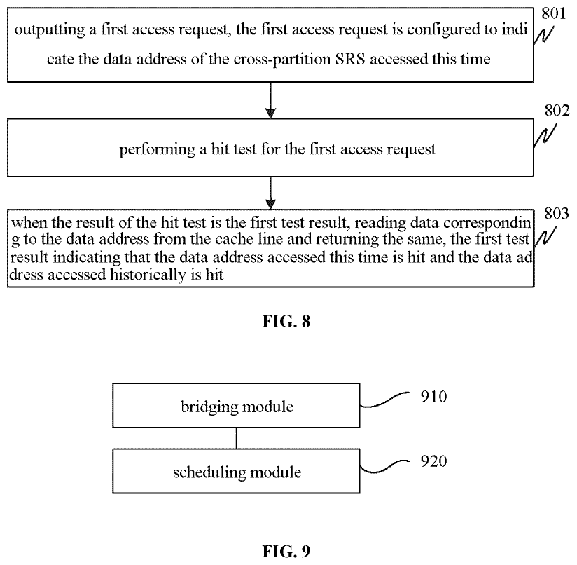

Please refer to FIG. 8, which is a flow chart of the data access processing method for a GPU provided in another exemplary embodiment of the present disclosure. This embodiment is described exemplarily for the method as applied to the GPU shown in FIG. 1. The method comprises the following steps:

Step 801, outputting a first access request, the first access request configured to indicate a data address of the cross-partition scalar register SRS accessed this time.

Step 802, performing a hit test for the first access request.

Step 803, when the result of the hit test is the first test result, reading data corresponding to the data address from the cache line and returning the same, the first test result indicating that the data address accessed this time is hit and the data address accessed historically is hit.

It is noted that details of each step in the embodiment of the present disclosure may refer to relevant description of the afore-described embodiments, which will not be repeated herein.

Please refer to FIG. 9, which is a structural diagram of the data access processing apparatus for a GPU provided in an embodiment of the present disclosure. The apparatus may be implemented, through a dedicated hardware circuit or a combination of software and hardware, as the entirely or a part of the GPU illustrated in FIG. 1. The apparatus comprises a bridging module 910 and a scheduling module 920. The bridging module 910 comprises a requesting unit and a scheduling multiplexing unit. The scheduling module 920 comprises a SRS;

The bridging module 910 is configured to output, by the requesting unit, a first access request, the first access request configured to indicate the data address of the cross-partition SRS of the scheduling module 920 accessed this time;

The bridging module 910 is configured further to perform a hit test for the first access request by the scheduling multiplexing unit;

The bridging module 910 is configured further to read and return data corresponding to the data address from the cache line of the scheduling module 920 when the result of the hit test is the first test result, the first test result indicating that the data address accessed this time is hit and the data address accessed historically is hit.

In a possible implementation, the bridging module 910 is configured further to:
acquire, according to the data address accessed this time, an index of the corresponding first cache line from the Look-up Table Address Queue;
acquire, according to the index of the first cache line, corresponding data from the Look-up Table Data Queue;
return the data acquired after performing a flopping operation thereon, the flopping operation configured to indicate outputting the data after delaying the data by k clock cycles, the k being an integer.

In one other possible implementation, the bridging module 910 is configured further to:
store the data address accessed this time in the Status Queue when the result of the hit test is the second test result, the Status Queue configured to indicate returning corresponding data in turn according to the access order;
wherein the second test result indicates that the data address accessed this time is hit and a data address accessed historically is not hit, or the data address accessed this time is not hit.

In one other possible implementation, the depth of the Status Queue is set according to a data cycle from outputting the first access request to returning data.

In one other possible implementation, the Status Queue is configured to store a data address that is not hit and a second data address that is hit in a case that a first data address is not hit, the first data address being a data address accessed before the second data address is accessed.

In one other possible implementation, the updating condition for the Status Queue includes:
updating data in the Status Queue when the earliest data address in the Status Queue is identical to a return address in a Return Address Queue.

In one other possible implementation, the bridging module 910 further comprises an arbiter, and the bridging module 910 is configured further to:
determine, in a Lock Flag Queue, a second cache line that is not locked, Lock Flag Queue indicating whether or not each cache line in a Look-up Table Address Queue is locked;
update the data address accessed this time in the corresponding second cache line of the Look-up Table Data Queue, and update the Valid Flag corresponding to the second cache line in the Look-up Table Valid Queue to the first flag, the first flag configured to indicate that data is invalid;
send the first access request to the arbiter, the arbiter configured to select among a plurality of cross-partition access requests.

In one other possible implementation, the bridging module 910 further comprises a First Input First Output FIFO memory, the bridging module 910 is configured further to:
hit, by the arbiter, a second access request, the second access request being one access request of the plurality of cross-partition access requests;
send, by the FIFO memory, a data address indicated by the second access request to the SRS in the scheduling module 920;
acquire, according to a data address of return data returned by the SRS, an index of a corresponding third cache line from a Look-up Table Address Queue;
update, according to the index of the third cache line, the return data in the third cache line of a Look-up Table Data Queue, and update a Valid Flag corresponding to the third cache line in the Look-up Table Valid Queue to a second flag, the second flag configured to indicate that data is valid.

In one other possible implementation, the bridging module 910 further comprises a comparing unit, the bridging module 910 is configured further to:
perform, by the comparing unit, detection on the Status Queue, the Look-up Table Address Queue, and the Look-up Table Valid Queue;
when the data address accessed the earliest in the Status Queue is identical to a data address in the Look-up Table Address Queue, and a corresponding Valid Flag indicates that data in a fourth cache line is valid, read data from the fourth cache line and return the same.

In one other possible implementation, the apparatus is implemented through a hardware circuit.

It is noted that the apparatus provided in the foregoing embodiments are exemplarily explained based on the afore-described division of functional modules for realizing the functions. In actual application, the functions may be assigned to different functional modules as needed; that is, the internal structure of the apparatus may be divided into different functional modules in order to accomplish all or part of the afore-described functions. In addition, the apparatus provided in the foregoing embodiments belong to one common concept with the afore-described method embodiments, of which the specific implementation has been described in the method embodiments and will not be repeated herein.

An embodiment of the present disclosure provides a data access processing apparatus for a GPU, comprising: a processor; a memory configured to store processor-executable instructions, wherein the processor is configured to, when executing the instructions, implement the method executed by the GPU in each of the afore-described method embodiments.

An embodiment of the present disclosure provides a non-transitory computer readable storage medium having computer program instructions stored thereon, wherein the computer program instructions, when executed by a processor, implement the method executed by the GPU in each of the afore-described method embodiments.

An embodiment of the present disclosure provides a computer program product comprising computer readable code, or a non-transitory computer readable storage medium carrying computer readable code, wherein when the computer readable code runs in a computer device, a processor of the computer device executes the method executed by the GPU in each of the afore-described method embodiments.

The present disclosure may be a system, a method, and/or a computer program product. The computer program product includes a computer readable storage medium having computer readable program instructions for causing a processor to implement various aspects of the present disclosure stored thereon.

The computer readable storage medium is a tangible device that can retain and store instructions used by an instruction executing device. The computer readable storage medium is not limited to, for example, an electronic storage device, magnetic storage device, optical storage device, electromagnetic storage device, semiconductor storage device, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. A computer readable storage medium referred herein should not to be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein can be downloaded to individual computing/processing devices from a computer readable storage medium or to an external computer or external storage device via network, for example, the Internet, local area network, wide area network and/or wireless network. The network comprises copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium in the respective computing/processing devices.

Computer readable program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with remote computer, the remote computer can be connected to the user's computer through any type of network, including local area network (LAN) or wide area network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; the electronic circuitry may execute the computer readable program instructions, so as to achieve various aspects of the present disclosure.

Aspects of the present disclosure have been described herein with reference to the flowchart and/or the block diagrams of the method, device (systems), and computer program product according to the embodiments of the present disclosure. It will be appreciated that each block in the flowchart and/or the block diagram, and combinations of blocks in the flowchart and/or block diagram, can be implemented by the computer readable program instructions.

These computer readable program instructions may be provided to a processor of a general purpose computer, a dedicated computer, or other programmable data processing devices, to produce a machine, such that the instructions create means for implementing the functions/acts specified in one or more blocks in the flowchart and/or block diagram when executed by the processor of the computer or other programmable data processing devices. These computer readable program instructions may also be stored in a computer readable storage medium, wherein the instructions cause a computer, a programmable data processing device and/or other devices to function in a particular manner. Thus, the computer readable storage medium having the instructions stored therein comprises a product that includes instructions implementing aspects of the functions/acts specified in one or more blocks in the flowchart and/or block diagram

The computer readable program instructions may also be loaded onto a computer, other programmable data processing devices, or other devices to have a series of operational steps performed on the computer, other programmable data processing devices or other devices, so as to produce a computer implemented process, such that the instructions executed on the computer, other programmable data processing devices or other devices implement the functions/acts specified in one or more blocks in the flowchart and/or block diagram.

The flowcharts and block diagrams in the drawings illustrate the architecture, function, and operation of possible implementations of the system, method, and computer program product according to the various embodiments of the present disclosure. In this regard, each block in the flowchart or block diagram may represent a part of a module, a program segment, or an instruction, which comprises one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart, and combinations of blocks in the block diagram and/or flowchart, can be implemented by dedicated hardware-based systems performing the specified functions or acts, or by combinations of dedicated hardware and computer instructions.

Although the embodiments of the present disclosure have been described above, it will be appreciated that the above descriptions are merely exemplary, but not exhaustive; and that the disclosed embodiments are not limiting. A number of variations and modifications may occur apparently to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. A data access processing apparatus for a GPU, comprising: a bridging module and a scheduling module, the bridging module comprising a requesting unit and a scheduling multiplexing unit, the scheduling module comprising a scalar register, SRS;
the bridging module configured to output, by the requesting unit, a first access request, the first access request configured to indicate a data address of the SRS of the scheduling module being cross-partition accessed for the first access;
the bridging module configured further to perform, by the scheduling multiplexing unit, a hit test for the first access request;
the bridging module configured further to read and return data corresponding to the data address from a cache line of the scheduling module based on that a result of the hit test is a first test result, the first test result indicating that the data address accessed for the first access is hit and a data address accessed historically is hit.

2. The apparatus according to claim 1, wherein the bridging module is configured further to:
acquire, based on the data address accessed for the first access, an index of a corresponding first cache line from a Look-up Table Address Queue;
acquire, based on the index of the first cache line, corresponding data from a Look-up Table Data Queue;
return the data acquired after performing a flopping operation thereon, the flopping operation configured to indicate outputting the data after delaying the data by k clock cycles, the k being an integer.

3. The apparatus according to claim 1, wherein the bridging module is configured further to:
store the data address accessed for the first access in a Status Queue based on that a result of the hit test is a second test result, the Status Queue configured to indicate returning corresponding data in turn based on an access order;
wherein the second test result indicates that the data address accessed for the first access is hit and the data address accessed historically is not hit, or the data address accessed for the first access is not hit.

4. The apparatus according to claim 3, wherein a depth setting of the Status Queue is set based on a data cycle from outputting the first access request to returning data.

5. The apparatus according to claim 3, wherein the Status Queue is configured to store a data address that is not hit and a second data address that is hit in a case that a first data address is not hit, the first data address being a data address accessed before the second data address is accessed.

6. The apparatus according to claim 3, wherein an updating condition for the Status Queue includes:
updating data in the Status Queue based on that an earliest data address in the Status Queue is identical to a return address in a Return Address Queue.

7. The apparatus according to claim 3, wherein the bridging module further comprises an arbiter, the bridging module is configured further to:
determine, in a Lock Flag Queue, a second cache line that is not locked, the Lock Flag Queue indicating whether or not each cache line in a Look-up Table Address Queue is locked;
update the data address accessed for the first access in the corresponding second cache line of the Look-up Table Data Queue, and update a Valid Flag corresponding to the second cache line in a Look-up Table Valid Queue to a first flag, the first flag configured to indicate that data is invalid;
send the first access request to the arbiter, the arbiter configured to select among a plurality of cross-partition access requests.

8. The apparatus according to claim 7, wherein the bridging module further comprises a First Input First Output, FIFO, memory, the bridging module is configured further to:
hit, by the arbiter, a second access request, the second access request being one access request among the plurality of cross-partition access requests;
send, by the FIFO memory, a data address indicated by the second access request to the SRS in the scheduling module;
acquire, based on a data address of return data returned by the SRS, an index of a corresponding third cache line from a Look-up Table Address Queue;
update, based on the index of the third cache line, the return data in the third cache line of a Look-up Table Data Queue, and update a Valid Flag corresponding to the third cache line in a Look-up Table Valid Queue to a second flag, the second flag configured to indicate that data is valid.

9. The apparatus according to claim 8, wherein the bridging module further comprises a comparing unit, the bridging module is configured further to:
perform, by the comparing unit, detection on the Status Queue, the Look-up Table Address Queue, and the Look-up Table Valid Queue;
read and return data from a fourth cache line based on that a data address of an earliest access in the Status Queue is identical to a data address in the Look-up Table Address Queue, and that a corresponding Valid Flag indicates that the data in the fourth cache line is valid.

10. The apparatus according to claim 1, wherein the apparatus is implemented through a hardware circuit.

11. A data access processing method for a GPU, wherein the method comprises:
outputting a first access request, the first access request configured to indicate a data address of a cross-partition scalar register SRS accessed for the first access;
performing a hit test for the first access request;
reading and returning data corresponding to the data address from a cache line based on that a result of the hit test is a first test result, the first test result indicating that the data address accessed for the first access is hit and a data address accessed historically is hit.

12. The method according to claim 11, wherein the reading and returning data corresponding to the data address from a cache line based on that a result of the hit test is the first test result comprises:
acquiring, based on the data address accessed for the first access, an index of a corresponding first cache line from a Look-up Table Address Queue;
acquiring, based on the index of the first cache line, corresponding data from a Look-up Table Data Queue;
returning the data acquired after performing a flopping operation thereon, the flopping operation configured to indicate outputting the data after delaying the data by k clock cycles, the k being an integer.

13. The method according to claim 11, further comprising:
storing the data address accessed for the first access in a Status Queue based on that a result of the hit test is a second test result, the Status Queue configured to indicate returning corresponding data in turn based on an access order;
wherein the second test result indicates that the data address accessed for the first access is hit and the data address accessed historically is not hit, or that the data address accessed for the first access is not hit.

14. The method according to claim 13, wherein a depth of the Status Queue is set based on a data cycle from outputting the first access request to returning the data.

15. The method according to claim 13, wherein the Status Queue is configured to store a data address that is not hit and a second data address that is hit in a case that a first data address is not hit, the first data address being a data address accessed before the second data address is accessed.

16. The method according to claim 13, wherein an updating condition for the Status Queue includes:
updating data in the Status Queue based on that an earliest data address in the Status Queue is identical to a return address in a Return Address Queue.

17. The method according to claim 13, further comprising, subsequent to storing the data address accessed for the first access in the Status Queue based on that the result of the hit test is the second test result:
determining, in a Lock Flag Queue, a second cache line that is not locked, the Lock Flag Queue indicating whether or not each cache line in a Look-up Table Address Queue is locked;
updating the data address accessed for the first access in the corresponding second cache line of the Look-up Table Data Queue, and updating a Valid Flag corresponding to the second cache line in a Look-up Table Valid Queue to a first flag, the first flag configured to indicate that data is invalid;
sending the first access request to an arbiter, the arbiter configured to select among a plurality of cross-partition access requests.

18. The method according to claim 17, further comprising:
hitting, by the arbiter, a second access request, the second access request being one access request among the plurality of cross-partition access requests;
sending a data address indicated by the second access request to the SRS;
acquiring, based on a data address of return data returned from the SRS, an index of a corresponding third cache line from a Look-up Table Address Queue;
updating, based on the index of the third cache line, the return data in the third cache line of a Look-up Table Data Queue, and updating a Valid Flag corresponding to the third cache line in a Look-up Table Valid Queue to a second flag, the second flag configured to indicate that the data is valid.

19. The method according to claim 18, further comprising:
performing detection on the Status Queue, the Look-up Table Address Queue, and the Look-up Table Valid Queue;
reading and returning data from a fourth cache line based on that a data address of an earliest access in the Status Queue is identical to a data address in the Look-up Table Address Queue, and that a corresponding Valid Flag indicates that data in the fourth cache line is valid.

20. A computer program product comprising computer readable code, or a non-transitory computer readable storage medium carrying the computer readable code, wherein when the computer readable code runs in a computer device, a processor of the computer device executes a data access processing method for a GPU, wherein the method comprises:
outputting a first access request, the first access request configured to indicate a data address of a cross-partition scalar register SRS accessed for the first access;
performing a hit test for the first access request;
reading and returning data corresponding to the data address from a cache line based on that a result of the hit test is a first test result, the first test result indicating that the data address accessed for the first access is hit and a data address accessed historically is hit.
